(19) United States
(12) Patent Application Publication
(10) Pub. No.: US 2016/0078479 A1
(43) Pub. Date: Mar. 17, 2016

(54) Generating an Advertisement Associated with a Multi-Party Communication Session and a Named Topic

(71) Applicants: Frances Bordwell Haugen, Mountain View, CA (US); Alexander Ketner Unger, San Francisco, CA (US)

(72) Inventors: Frances Bordwell Haugen, Mountain View, CA (US); Alexander Ketner Unger, San Francisco, CA (US)

(73) Assignee: GOOGLE INC., Mountain View, CA (US)

(21) Appl. No.: 13/448,346

(22) Filed: Apr. 16, 2012

(51) Int. Cl. G06Q 30/02; G06Q 50/00

(52) U.S. Cl. CPC G06Q 30/0256; G06Q 30/0255; G06Q 30/0277; G06Q 50/01

(57) ABSTRACT

A system and method for generating an advertisement are disclosed. In one embodiment, the system includes a display document request receiver module, an ad selection module, a topic determination module and an ad display module. The display document request receiver module receives a request for a display document associated with a keyword signal. The ad selection module selects, based at least in part on the keyword signal, an advertisement that is associated with a multi-party communication session and at least one named topic. The topic determination module selects a named topic based at least in part on a topic specifying input. The ad display module provides the selected advertisement including the selected topic and a selection element for selecting the communication session associated with the advertisement for display. Multiple topics may be associated with one communication session and therefore one of those topics may be displayed based on an input.

The specification relates to online advertising. In particular, the specification relates to generating an advertisement associated with a multiparty communication session and a named topic.

### BACKGROUND

Advertisements shown on the Internet can get there in a number of ways. Advertising campaigns can be set up or associated with advertisers (e.g., a company or an advertising agency). An advertiser can have multiple advertising campaigns. The advertising campaigns can have budgets associated therewith to control the “spend” associated with advertising over time. The advertisements matched to individual pages can be done in a number of ways. For example, advertisement may be matched based on query search terms, the content of a webpage or news article, the content of received email, the content of a user's social networking stream, etc. One thing that has been missing in the world of online advertising is a process by which companies can present communication sessions as part of their advertising. Another thing that has been missing from the world of online advertising is a process for selecting a named topic associated with an advertisement based at least in part on an input.

### SUMMARY

The specification overcomes the deficiencies and limitations of the prior art at least in part by providing a system and method for generating an advertisement associated with a multiparty communication session and a named topic.

In some examples, the specification describes a system, method and computer program product for generating an advertisement associated with a multiparty communication session and a named topic. In one example, the system comprises a display document request receiver module, an ad selection module, a topic determination module and an ad display module.

The display document request receiver module receives a request for a display document, wherein the requested display document has associated therewith one or more keyword signals. In some embodiments, the one or more keyword signals are based at least in part on a search query. In some embodiments, the one or more keyword signals are based at least in part on content of one or more e-mails. In some embodiments, the one or more keyword signals are based at least in part on the content of a webpage. In some embodiments, the one or more keyword signals are based at least in part on content associated with a first user's social network account.

The ad selection module selects an advertisement based at least in part on the one or more keyword signals associated with the requested display document, wherein the advertisement includes additional information and is associated with a multi-party communication session and at least one named topic, wherein the multi-party communication session is associated with one or more moderators.

The topic determination module selects a named topic based at least in part on a topic specifying input. In some embodiments, the topic specifying input is based at least in part on a question from a user, the question submitted in the multi-party communication session associated with the advertisement. In some embodiments, the topic specifying input comprises text typed by the one or more moderators into a text field, and the topic determination module determines the named topic based at least in part on the text. In some embodiments, the topic specifying input is received from the one or more moderators and describes the current topic of the multi-party communication session associated with the advertisement.

The ad display module provides the selected advertisement and the named topic for display with the display document, including providing for display a selection element for selecting the multi-party communication session associated with the advertisement. In some embodiments, the named topic provided for display by the ad display module is dynamic.

In some embodiments, the system includes an enrollment module that receives the topic specifying input from an advertiser, the topic specifying input associating a potential named topic with one or more keyword signals associated with the advertisement, and the topic determination module selects the potential named topic when the one or more keyword signals associated with the requested display document at least partially match the one or more keywords associated with the potential named topic.

The features and advantages described herein are not all-inclusive and many additional features and advantages will be apparent in view of the figures and description. Moreover, it should be noted that the language used in the specification has been principally selected for readability and instructional purposes, and not to limit the scope of the subject matter disclosed herein.

### BRIEF DESCRIPTION OF THE DRAWINGS

The embodiments are illustrated by way of example, and not by way of limitation in the figures of the accompanying drawings in which like reference numerals are used to refer to similar elements.

FIG. 1 illustrates a system for generating an advertisement associated with a multiparty communication session and a named topic according to one embodiment.

FIG. 2 is a block diagram illustrating a computing device according to one embodiment.

FIG. 3 is a block diagram illustrating a visual broadcast module according to one embodiment.

FIG. 4 is a flow chart illustrating a method for generating an advertisement associated with a multiparty communication session and a named topic according to one embodiment.

FIG. 5 is a flow chart illustrating another method for generating an advertisement associated with a multiparty communication session and a named topic according to another embodiment.

FIG. 6 is a flow chart illustrating another method for generating an advertisement associated with a multiparty communication session and a named topic according to yet another embodiment.

### DETAILED DESCRIPTION

A system and method for generating an advertisement associated with a multiparty communication session and a named topic are described.

A system and method by which companies can present communication sessions as part of their advertising are disclosed. Embodiments herein provide for such abilities. As an example, when a user might search for “Buying a used car.” As part of delivering that page, the search terms may be matched by a server to an advertisement for Automotive Brand XYZ, and possibly more specifically to a dealership ABC's sale on used cars. The advertisement may have therewith associated a communication session, in which the user can engage by clicking a link. When the user clicks that link, she may be connected via a communication session (e.g., a chat session, voice conference, or video conference) to a used car specialist from Company ABC. The representative and the user can then discuss what to look for in a used car and/or used car dealer, current inventory, pricing, etc.

In some embodiments herein, when a user requests a web page (e.g., search results, a page for her social networking stream, etc.) a request for delivery of an advertisement for that web page may be generated. That request may be based on a search query, the content of a web page, etc. The request may contain one or more keywords (e.g., keywords derived based on the webpage, search query, social network stream, etc). Those keywords can be used to match the request to an advertisement (e.g., from an advertising campaign). Using the techniques herein, the advertisement may have associated therewith a communication session. That advertisement may then be presented to the end user as part of the web page associated with the request for an advertisement (e.g., the search results, news article, a page showing the user's social networking stream or email, etc.). The user will then see the advertisement, with the associated communication session, on the web page.

When the user viewing the web page selects the communication session associated with the advertisement on the web page, the communication session can be initiated (e.g., using peer-to-peer communication or by connecting all participants using a central server). The communication session may have a representative or moderator (e.g., a customer service representative representing the company or a representative of the company trained to give advice regarding a particular topic) already in the session. In some embodiments, the communication session will be started upon the user selecting the link corresponding to the communication session. Regardless of the time of initiation, the communication session will connect the moderator with the user so that the user may interact with the moderator in order to, for example, ask questions about the product or service that is the subject of the advertisement.

Also is disclosed is displaying a topic associated with the communications session of the advertisement based at least in part on an topic-specified input (e.g., a question submitted by a client in the communication session, a topic selected by the moderator or other user, or a topic automatically determined based on the content of the discussion and changing the topic being displayed based at least in part of another topic-specified input.

In some embodiments, a topic may be associated and displayed with the link in the advertisement. In one embodiment, the topic is selected in advance by an advertiser. For example, the advertiser selects one or more topics when creating the campaign in order to reach a targeted demographic based on keywords. In one embodiment, the topic maximizes the probability that a user will click on the link and join the communications session. For example, the topic is selected to closely match the user's search query, the content of an email, etc. thereby increasing the probability that the user will believe the discussion is relevant and worth joining. In one embodiment, the topic is selected to accurately reflect the topic of the discussion in the communications session allowing the user to accurately determine the relevance of the discussion. For example, the topic of the discussion may not exactly match the search query and/or the topic of the discussion may have initially matched the search query but changed as the discussion continued. For example, a user and used car specialist may have originally been discussing what to look for in a used car but are more recently discussing current inventory. In one embodiment, the most recent question submitted by a user in the communication session is selected as the topic of the communication session and displayed with the link. In one embodiment, the moderator (e.g. the used car specialist) may select the topic associated with the communication session by entering the topic in a text field.

By presenting various ways to select the topic, this enables the ability to associate multiple topics with one communication session and therefore display one of those topics based on an input. This allows an advertiser to target across a broad set of keywords, and displaying different topics in the display block based on input, but still funnel all traffic into the same multi-party communication session.

In the following description, for purposes of explanation, numerous specific details are set forth in order to provide a thorough understanding of the embodiments. It will be apparent, however, to one skilled in the art that the embodiments can be practiced without these specific details. In other instances, structures and devices are shown in block diagram form in order to avoid obscuring the embodiments. For example, one embodiment is described below with reference to user interfaces and particular hardware. However, the present embodiments apply to any type of computing device that can receive data and commands, and any peripheral devices providing services.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including, for example, “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The embodiments can take the form of an entirely hardware embodiment, an entirely software embodiment or an embodiment containing both hardware and software elements. An exemplary embodiment is implemented in software, which includes but is not limited to firmware, resident software, microcode, etc.

Furthermore, the embodiments can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present embodiments are not described with reference to any particular programming language. It will be appreciated that a variety of programming languages may be used to implement the teachings of the embodiments as described herein.

### Example System Overview

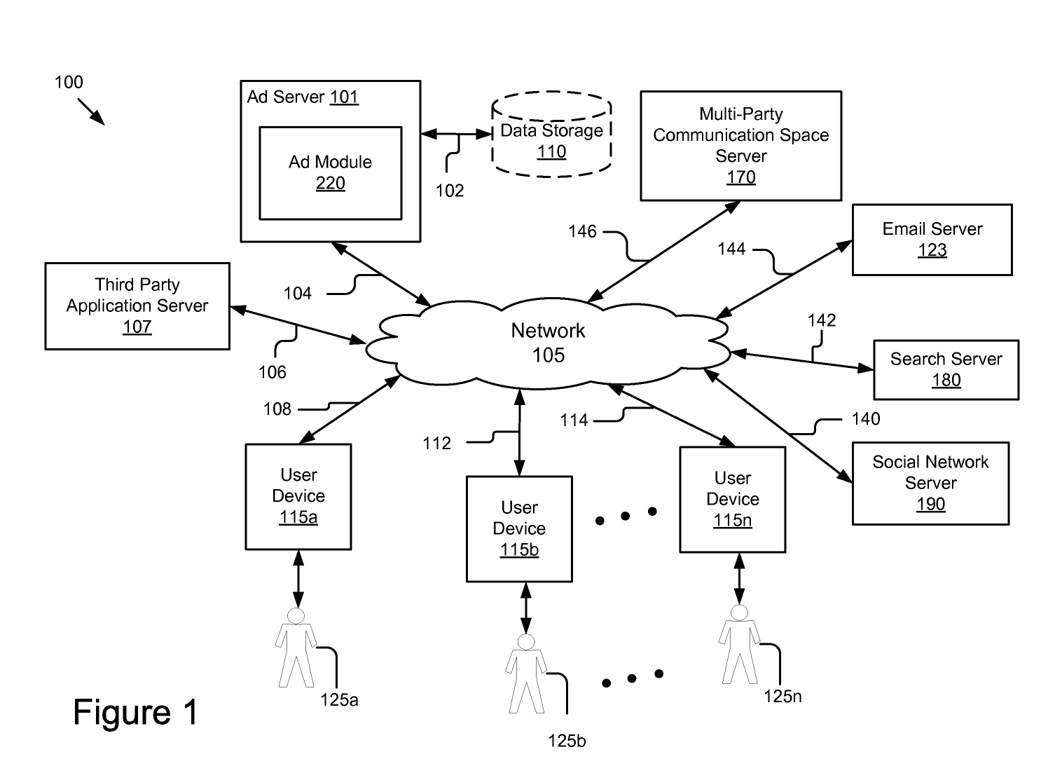

FIG. 1 illustrates a block diagram of a system 100 for generating an advertisement according to one embodiment. The illustrated system 100 includes user devices 115a, 115b, and 115n (also referred to collectively as user devices 115 or individually as user device 115) that are accessed by users 125a, 125b, and 125n (also referred to collectively as users 125 or individually as user 125), an ad server 101, a multi-party communications space server 170, an e-mail server 123, a search server 180, a social network server 190 and a third party application server 107. In the illustrated embodiment, these entities are communicatively coupled via a network 105. Although only three user devices 115 are illustrated, any number of user devices 115 are available to any number of users 125.

The user devices 115 in FIG. 1 are used by way of example. While FIG. 1 illustrates three user devices 115, the present specification applies to any system architecture having one or more user devices 115. Furthermore, while only one network 105 is coupled to the user devices 115, the third party application server 107, the ad server 101, the search server 180, the e-mail server 123, the social network server 190 and the multi-party communications space server 170, in practice any number of networks 105 can be connected to the entities. Furthermore, while only one third party server 107, one email server 123, one search server 180 and one social network server 190 are shown, the system 100 can include any number of servers 107, 123, 180 and 190.

Although only one multi-party communication space server 170 is shown, it will be recognized that multiple servers may be present. In one embodiment, the multi-party communication space server 170 comprises, or is comprised within, a social network. A social network is any type of social structure where the users are connected by a common feature. Examples include, but are not limited to, blogs, microblogs and Internet forums. The common feature includes friendship, family, a common interest, etc.

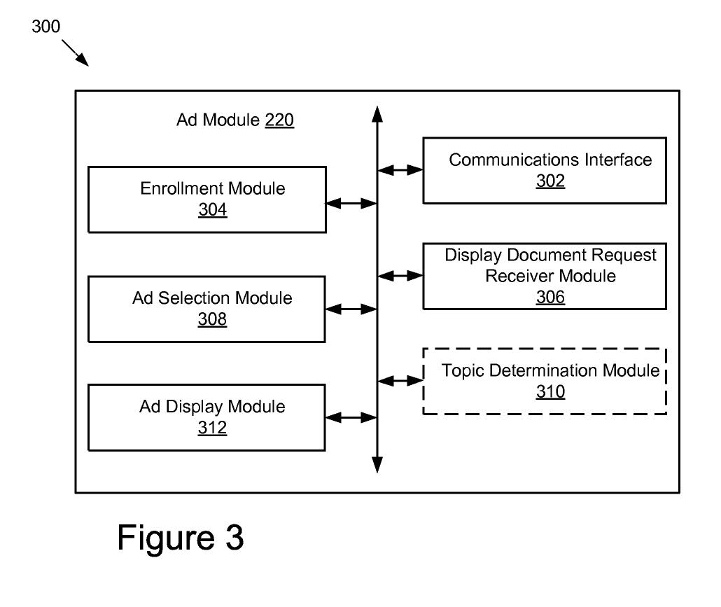

Although only one ad server 101 is shown, it will be recognized that multiple ad servers 101 may be present. In one embodiment, an ad module 220 is included in the ad server 101 and is operable on the ad server 101, which is connected to the network 105 via signal line 104. Details describing the functionality and components of the ad module 220 are explained in further detail below with regard to FIG. 3.

The network 105 enables communications between user devices 115, the ad server 101, the user application servers 130, the search server 180, the e-mail server 123, the social network server 190 and the third party application 107 server. Thus, the network 105 can include links using technologies including, for example, Wi-Fi, Wi-Max, 2G, Universal Mobile Telecommunications System (UMTS), 3G, Ethernet, 802.11, integrated services digital network (ISDN), digital subscriber line (DSL), asynchronous transfer mode (ATM), InfiniBand, PCI Express Advanced Switching, etc. Similarly, the networking protocols used on the network 105 can include the transmission control protocol/Internet protocol (TCP/IP), multi-protocol label switching (MPLS), the User Datagram Protocol (UDP), the hypertext transport protocol (HTTP), the simple mail transfer protocol (SMTP), the file transfer protocol (FTP), lightweight directory access protocol (LDAP), Code Division Multiple Access (CDMA), Wideband Code Division Multiple Access (WCDMA), Global System for Mobile communications (GSM), High-Speed Downlink Packet Access (HSDPA), etc. The data exchanged over the network 105 can be represented using technologies and/or formats including the hypertext markup language (HTML), the extensible markup language (XML), etc. In addition, all or some of links can be encrypted using conventional encryption technologies, for example, the secure sockets layer (SSL), Secure HTTP and/or virtual private networks (VPNs) or Internet Protocol security (IPsec). In another embodiment, the entities can use custom and/or dedicated data communications technologies instead of, or in addition to, the ones described above. Depending upon the embodiment, the network 105 can also include links to other networks.

In one embodiment, the network 105 is a partially public or a wholly public network, for example, the Internet. The network 105 can also be a private network or include one or more distinct or logical private networks (e.g., virtual private networks, Wide Area Networks (“WAN”) and/or Local Area Networks (“LAN”)). Additionally, the communication links to and from the network 105 can be wireline or wireless (i.e., terrestrial or satellite-based transceivers). In one embodiment, the network 105 is an IP-based wide or metropolitan area network.

In some embodiments, the network 105 helps to form a set of online relationships between users 125, for example, those provided by one or more social networking systems including explicitly-defined relationships and relationships implied by social connections with other online users, where the relationships form a social graph. In some examples, the social graph can reflect a mapping of these users and how they are related.

In the illustrated embodiment, the user devices 115a, 115b and 115n are coupled to the network 105 via signal lines 108, 112 and 114, respectively. The user 125a can interact with the user device 115a. Similarly, the user 125b can interact with the user device 115b, and the user 125n can interact with the user device 115n. The third party application server 107 is communicatively coupled to the network 105 via signal line 106. The e-mail server 123 is communicatively coupled to the network 105 via signal line 144. The search server 180 is communicatively coupled to the network 105 via signal line 142. The ad server 101 is communicatively coupled to the network 105 via signal line 104. In one embodiment, the ad server 101 is communicatively coupled to data storage 110 via signal line 102. The multi-party communication space server 170 is communicatively coupled to the network 105 via signal line 146. The social network server 190 is communicatively coupled to the network 105 via signal line 140.

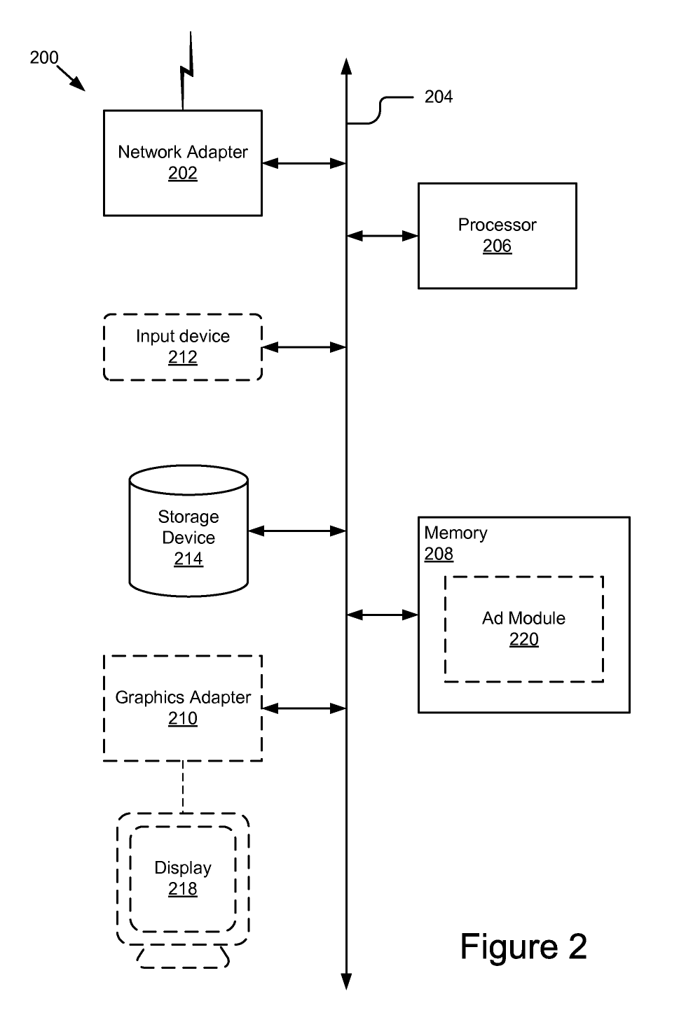

In one embodiment, the data storage 110 stores data and information of each advertisement of the ad server 101. In one embodiment, the stored data and information includes data and information associated with an advertisement. Examples of data and information associated with an advertisement include, but are not limited to, one or more of an advertiser, one or more keyword signals, a format, multi-part communication session information, etc. In one embodiment, the information stored in data storage 110 also includes, one or more topic specifying inputs, for example, one or more groups of one or more keyword signals each associated with an advertiser specified named topic. In one embodiment, which is discussed below, a storage device 214 (see FIG. 2) is included in the ad server 101 (i.e., a computing device 200) and the storage device 214 stores the data and information of each advertisement of the ad server 101.

In one embodiment, the user device 115 is an electronic device having a web browser (not shown) for interacting with the various servers 101, 107, 123, 170, 180, 190 and user devices 115 of the system 100 via the network 105 and is used by a user 125 to access information in the system 100. The user device 115 can be, for example, a laptop computer, a desktop computer, a tablet computer, a mobile telephone, a personal digital assistant (PDA), a mobile email device, a portable game player, a portable music player or any other electronic device capable of accessing a network. One having ordinary skill in the art will recognize that other types of client devices 115 are possible. In one embodiment, the system 100 comprises a combination of different types of client devices 115. For example, a combination of a personal computer, a mobile phone and a tablet computer. The user 125 is a human user of the user device 115.

### Example Computing Device 200

FIG. 2 is a block diagram of a computing device 200 according to one embodiment. As illustrated in FIG. 2, the computing device 200 includes a network adapter 202 coupled to a bus 204. According to one embodiment, also coupled to the bus 204 are at least one processor 206, a memory 208, a graphics adapter 210, an input device 212 and a storage device 214. In one embodiment, the memory 208 comprises an ad module 220. In one embodiment, the functionality of the bus 204 is provided by an interconnecting chipset. The computing device 200 also includes a display 218, which is coupled to the graphics adapter 210.

The processor 206 may be any general-purpose processor. The processor 206 comprises an arithmetic logic unit, a microprocessor, a general purpose controller or some other processor array to perform computations and execute code and routines. The processor 206 is coupled to the bus 204 for communication with the other components of the computing device 200. Processor 206 processes data signals and may comprise various computing architectures including a complex instruction set computer (CISC) architecture, a reduced instruction set computer (RISC) architecture, or an architecture implementing a combination of instruction sets. Although only a single processor is shown in FIG. 2, multiple processors may be included. The processing capability may be limited to supporting the display of images and the capture and transmission of images. The processing capability might be enough to perform more complex tasks, including various types of feature extraction and sampling. The computing device 200 also includes an operating system executable by the processor including but not limited to WINDOWS®, MacOS X, Android or UNIX® based operating systems. It will be obvious to one skilled in the art that other processors, operating systems, sensors, displays and physical configurations are possible.

The memory 208 is a non-transitory storage medium. The memory 208 holds instructions and/or data that may be executed by the processor 206. In one embodiment, the instructions and/or data stored on the memory 208 comprise code for performing any and/or all of the techniques described herein. The memory 208 may be a dynamic random access memory (DRAM) device, a static random access memory (SRAM) device, flash memory or some other memory device known in the art. In one embodiment, the memory 208 also includes a non-volatile memory or similar permanent storage device and media, for example, a hard disk drive, a floppy disk drive, a CD-ROM device, a DVD-ROM device, a DVD-RAM device, a DVD-RW device, a flash memory device, or some other mass storage device known in the art for storing information on a more permanent basis. The memory 208 is coupled by the bus 204 for communication with the other components of the computing device 200. In one embodiment, the ad module 220 is stored in memory 208 and executable by the processor 206.

The computing device 200, in one embodiment, is an ad server 101. In one such embodiment, the ad server 101 contains the ad module 220. Details describing the functionality and components of the ad module 220 are explained in further detail below with regard to FIG. 3.

In one embodiment, the computing device 200 is a multi-party communication space server 170. An embodiment of the multi-party communication space server 170 allows multiple users to communicate in a multi-party communication session. For example, in one embodiment, participants of the multi-party communication session are all connected to the multi-part communication space server 170, which is a central server. In another embodiment, a multi-party communication session uses peer-to-peer communication.

In one embodiment, the multi-party communication session includes a primary user (e.g. a moderator) and one or more secondary users and allows the users to communicate with one another. In one embodiment, communication between one or more users is unilateral. For example, a user in the multi-party communication session may see and/or hear the other participants in the multi-party communication session, but the user may not be seen and/or heard by the other users. In one embodiment, a multi-party communication session is public allowing any user to join the multiparty communication session. In some embodiments, a user must be logged in (e.g. logged into the multi-party communication space server 170) in order to join a multi-party communication session.

A multi-party communication session allows for one or more of audio and visual communication. Examples of a multi-party communication session include but are not limited to one or more of a chat session, voice conference, video conference, etc. In one embodiment, a multi-party communication session displays video or other representations of participating users. In one such embodiment, the multi-party communication session includes both audio and video communication. It will be realized that the preceding are merely examples of multi-party communications sessions and that other examples exist.

In one embodiment, the computing device 200 is a social network server 190. An embodiment of the social network server 190 allows users 125 of user devices 115 to perform social functions between other users 125 of user devices 115 within the system 100. In one embodiment, the social network server 190 comprises, or is comprised within, a social network. In another embodiment, the computing device 200 is an email server 123. In another embodiment, the computing device 200 is a third party server 107. In another embodiment, the computing device 200 is a search server 180.

The storage device 214 is any device capable of holding data, like a hard drive, compact disk read-only memory (CD-ROM), DVD, or a solid-state memory device. The storage device 214 is a non-volatile memory device or similar permanent storage device and media. The storage device 214 stores data and instructions for processor 208 and comprises one or more devices including a hard disk drive, a floppy disk drive, a CD-ROM device, a DVD-ROM device, a DVD-RAM device, a DVD-RW device, a flash memory device, or some other mass storage device known in the art. In one embodiment, the computing device 200 is an ad server 101 and the storage device 214 stores data and information of each advertisement of the ad server 101. For example, the data and information discussed above in reference to data storage 110.

The input device 212 may include a mouse, track ball, or other type of pointing device to input data into the computing device 200. The input device 212 may also include a keyboard, for example, a QWERTY keyboard or any other physical or soft keyboard in any language. The input device 212 may also include a microphone, a web camera or similar audio or video capture device. The graphics adapter 210 displays images and other information on the display 218. The display 218 is a conventional type, for example, a liquid crystal display (LCD) or any other similarly equipped display device, screen, touchscreen or monitor. The display 218 represents any device equipped to display electronic images and data as described herein. The network adapter 202 couples the computing device 200 to a local or wide area network.

The ad module 220 may include code and routines executable by the processor 206 for generating an advertisement associated with a multiparty communication session and a named topic. In one embodiment, the ad module 220 is a set of instructions executable by the processor 206. In another embodiment, the ad module 220 is stored in the memory 208 and is accessible and executable by the processor 206. Details describing the functionality and components of the ad module 220 are explained in further detail below in reference to FIG. 3.

As is known in the art, a computing device 200 can have different and/or other components than those shown in FIG. 2. For example, the computing device can have speakers or another form of audio output. In addition, the computing device 200 can lack certain illustrated components. For example, in one embodiment, the computing device 200 is an ad server 101 and lacks an input device 212, graphics adapter 210 and/or display 218. Moreover, the storage device 214 can be local and/or remote from the computing device 200 (e.g., a storage area network (SAN)).

As is known in the art, the computing device 200 is adapted to execute computer program modules for providing the functionality described herein. As used herein, the term “module” refers to computer program logic utilized to provide the specified functionality. Thus, a module can be implemented in hardware, firmware, and/or software. In one embodiment, program modules are stored on the storage device 214, loaded into the memory 208 and executed by the processor 206.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

### Example Ad Module 220

Referring now to FIG. 3, the ad module 220 is shown in more detail. FIG. 3 is a block diagram of the ad module 220 included in a computing device 200 (e.g., an ad server 101).

In one embodiment, the ad module 220 comprises a communications interface 302, an enrollment module 304, a display document request receiver module 306, an ad selection module 308, an optional topic determination module 310 and an ad display module 312.

It will be recognized that the modules 302, 304, 306, 308, 310, 312 comprised in the ad module 220 are not necessarily all on the same computing device 200. In one embodiment, the modules 302, 304, 306, 308, 310, 312 are distributed across multiple computing devices 200. For example, in one embodiment, the enrollment module 304 is included in one ad server 101 and the other modules 302, 306, 308, 310, 312 are included in another ad server 101. It will be recognized that the preceding is just an example of distributing modules across multiple computing devices 200 and that other examples exist.

The communication interface 302 may include code and routines may include code and routines for handling communications between the enrollment module 304, the display document request receiver module 306, the ad selection module 308, the topic determination module 310, the ad display module 312 and other components of the computing device 200. In one embodiment, the communication interface 302 is a set of instructions executable by the processor 206. In another embodiment, the communication interface 302 is stored in the memory 208 and is accessible and executable by the processor 206. In either embodiment, the communication interface 302 is adapted for cooperation and communication with the processor 206, other components of the computing device 200 and other components of the ad module 220.

The communication interface 302 handles communications between the enrollment module 304, the display document request receiver module 306, the ad selection module 308, the topic determination module 310, the ad display module 312 and other components of the computing device 200. For example, the communication interface 202 communicates with the ad selection module 308 and the ad display module 308 to pass the output of the ad selection module 308 (i.e., a selected advertisement) to the ad display module 312. However, this description may occasionally omit mention of the communication interface 302 for purposes of clarity and convenience. For example, for purposes of clarity and convenience, the above scenario may be described as the ad selection module 308 passing the selected advertisement to the ad selection module 308.

The enrollment module 304 may include code and routines for receiving one or more advertisements from an advertiser. In one embodiment, the enrollment module 304 is a set of instructions executable by the processor 206. In another embodiment, the enrollment module 304 is stored in the memory 208 and is accessible and executable by the processor 206. In either embodiment, the enrollment module 304 is adapted for cooperation and communication with the processor 206, other components of the computing device 200 and other components of the ad module 220.

The enrollment module 304 receives one or more advertisements from an advertiser. In one embodiment, an advertiser is a human user 125 from which the enrollment module 304 receives an advertisement (e.g. via a user device 115). For example, the advertiser may be associated with a company or an advertising agency. It will be recognized that the preceding are merely examples of advertisers and that other examples exist.

In one embodiment, an advertisement is associated with one or more advertiser selected keyword signals and/or one or more groups of keyword signals. For example, assume an advertiser advertising turkey and selects keyword signals “turkey” and “thanksgiving,” in one embodiment, the enrollment module 304 receives the keyword signals “turkey” and “thanksgiving” and associates the keyword signals with the advertisement. It will be recognized that the preceding is merely an example of keyword signals associated with an advertisement and that other keyword signals may be associated with an advertisement.

In one embodiment, an advertisement has a format. In one embodiment, an advertisement's format is advertiser selected. For example, the enrollment module 304 receives the advertisement and an advertiser's selection that the advertisement has a format consisting of text. In another example, the enrollment module 304 receives the advertisement and an advertiser's selection that the advertisement has a format of an advertisement associated with a multi-party communication session. An advertisement associated with a multi-party communication session is occasionally referred to herein as a “MPCS Ad.”

In one embodiment, when an advertisement is associated with a multi-party communication session, the enrollment module 304 receives information associated with the MPCS Ad that is not necessarily associated with advertisements that are not associated with a multi-party communication session. Such information uniquely associate with MPCS Ads is occasionally referred to herein as “multi-party communication session information.” In one embodiment, when an advertisement is associated with a multi-party communication session, the enrollment module 304 receives and/or provides multi-party communication session information. Examples of multi-party communication session information include but are not limited to one or more of a URL associated with a multi-party communication session, login information associated with a multi-party communication session, hours of operation associated with a multi-party communication session, one or more topics associated with the multi-party communication session, etc. It will be recognized that the preceding are merely examples of multi-party communication session information and that other examples exist.

In one embodiment, when an advertisement is associated with a multi-party communication session, the enrollment module 304 receives multi-party communication session information at least in part from the advertiser. For example, assume an advertiser intends to staff the multi-party communication session with a moderator from 9 am-5 pm Eastern Standard Time, in one embodiment, the enrollment module 304 receives the 9-to-5 hours of operation from the advertiser (e.g. via a user device). In another example, assume an advertiser possesses a URL associated with the multi-party communication session, in one embodiment, the enrollment module 304 receives the URL from the advertiser (e.g. via a user device). It will be recognized that the preceding are merely examples of receiving multi-party communication session information from a provider and that other examples exist.

In one embodiment, when an advertisement is associated with a multi-party communication session, the enrollment module 304 provides multi-party communication session information. For example, the enrollment module 304 is communicatively coupled to a multi-party communication space server 170 to create a multi-party communication session, receive a URL and login information for the multi-party communication session, which the enrollment module 304 associates with the MPCS Ad and provides to the advertiser. It will be recognized that the preceding are merely examples of providing multi-party communication session information and that other examples exist.

In one embodiment, one or more topics are associated with a MPCS Ad. In one embodiment, the enrollment module 304 receives advertiser input selecting one or more topics (i.e. topic specifying input). For example, assume an advertiser uploads an advertisement, selects keyword signals, selects the format associated with a multi-party communication session, provides multi-party communication session information, and inputs one or more named topics associated with the advertisement, in one embodiment, the enrollment module 304 receives the advertisement, the associated keyword signals, the format selection, the multi-party communication session information and the topic specifying input.

In one embodiment, topic specifying inputs from the advertiser are based at least in part on the one or more keyword signals associated with the advertisement. For example, assume an advertisement is associated with keyword signals including “cookies,” “bread,” “pie,” “casseroles” and “cake,” in one embodiment, the enrollment module 304 receives the named topic “baking” from an advertiser (e.g. via a user device 115). In one embodiment, multiple topics are associated with a single MPCS Ad and, therefore, the MPCS Ad's associated multi-party communication session. For example, assume a topic specifying input from an advertiser associates “cookies,” “pie” and “cake” with a “desserts” named topic and “bread” and “casseroles” with a “baking” named topic, in one embodiment, the enrollment module 304 receives the topic specifying input including the named topics and their associated keyword signal groups. It will be recognized that the preceding are merely examples of topic specifying input from an advertiser and named topics based at least in part on one or more keyword signals and that other examples exist. Moreover, it will be recognized that the preceding are merely examples of associating a named topic with MPCS Ad and that other examples exist.

In one embodiment, the enrollment module 304 passes the one or more advertisements to the ad selection module 308. For example, the enrollment module 304 is communicatively coupled to the ad selection module 308 to send the one or more advertisements to the ad selection module 308. In another embodiment, the enrollment module 304 (or the communication interface 302) stores the one or more advertisements in the storage device 214 (or any other non-transitory storage medium communicatively accessible). The other modules of the ad module 220 including the ad selection module 308 can retrieve the one or more advertisements by accessing the storage device 214 (or other non-transitory storage medium).

The display document request receiver module 306 may include code and routines for receiving a display document request. In one embodiment, the display document request receiver module 306 is a set of instructions executable by the processor 206. In another embodiment, the display document request receiver module 306 is stored in the memory 208 and is accessible and executable by the processor 206. In either embodiment, the display document request receiver module 306 is adapted for cooperation and communication with the processor 206, other components of the computing device 200 and other components of the ad module 220.

The display document request receiver module 306 receives a display document request. In one embodiment, a display document is any content accessible by a user in the system 100. Examples of a display document include but are not limited to one or more of a webpage, search results, social network stream, e-mail webpage of a user including a listing of e-mail messages and related content, digital video including pre-recorded video or live-streaming videos, etc. It will be recognized that the preceding are merely examples of a display document and other examples exist and the display documents may include items listed in the preceded example as well as additional content displayed with such items.

In one embodiment, the display document request includes one or more keyword signals associated with the requested display document. In one embodiment, a keyword signal is based at least in part on a search query (i.e. a request for a display document including search results). For example, assume the request for a display document is a search for “how to cook a turkey,” in one embodiment, the display document request receiver module 306 is communicatively coupled to the search server 180 to receive “turkey” (i.e. a keyword signal associated with the search results and based at least in part on the search query). It will be recognized that the preceding is merely an example of one or more keyword signals based at least in part on a search query and that other examples exist.

In one embodiment, a keyword signal is based at least in part on content of an e-mail. For example, assume the request for a display document is a request to open an e-mail (i.e. a display document) with “cookies” in the subject line and/or body of the e-mail, in one embodiment, the display document request receiver module 306 is communicatively coupled to the email server 123 to receive “cookies” (i.e. a keyword signal associated with the e-mail and based at least in part on the content of an e-mail). It will be recognized that the preceding is merely an example of one or more keyword signals based at least in part on the content of an e-mail and that other examples exist.

In one embodiment, a keyword signal is based at least in part on content the content of a webpage. For example, assume the request for a display document is a request to open a crafts webpage (i.e. a display document) associated with sewing and knitting (e.g. in headers and/or metadata), in one embodiment, the display document request receiver module 306 is communicatively coupled to the third party application server 107 hosting the website to receive “sewing” and “knitting” (i.e. keyword signals associated with the webpage and based at least in part on the content of a webpage). It will be recognized that the preceding is merely an example of one or more keyword signals based at least in part on the content of a webpage and that other examples exist.

In one embodiment, a keyword signal is based at least in part on content of social network stream. For example, assume the request for a display document is a request to open a thread of comments about going to a movie next Friday (i.e. a display document), in one embodiment, the display document request receiver module 306 is communicatively coupled to the social network server 190 to receive “movie” and “[next Friday's date]” (i.e. keyword signals associated with the social network stream and based at least in part on the content of a social network stream). It will be recognized that the preceding is merely an example of one or more keyword signals based at least in part on the content of a social stream and that other examples exist. Moreover, it will be recognized that the preceding are merely examples of bases for one or more keyword signals associated with a requested display document and that other examples exist.

In one embodiment, a keyword signal is based at least in part on content being displayed during a display of streaming video. For example, a user may be watching a stream of a video such as a sports game. In such example, a request for a display document may be a request to open a page to display streaming video or a request for to a document while a video is streaming. In such example, the keyword signal received may be based at least in part on the content of that video being streamed. In some embodiments, the display document request receiver module 306 is communicatively coupled to the third party application server 107 (which may host a video displaying website) to receive “football” (i.e. keyword signals associated with the streaming video and based at least in part on the content of a streaming video). It will be recognized that the preceding is merely an example of one or more keyword signals based at least in part on the content of a streaming video and that other examples exist. Moreover, it will be recognized that the preceding are merely examples of bases for one or more keyword signals associated with a requested display document and that other examples exist.

In one embodiment, the display document request receiver module 306 receives the one or more keyword signals associated with the requested display document when it determines the one or more keyword signals. In one embodiment, the display document request receiver module 306 determines the one or more keyword signals directly. For example, assume the display document request is a search query and the results page is the display document, in one embodiment, the display document request receiver module 306 analyzes one or more of the search query and the results page and determines the one or more keyword signals. It will be recognized that the preceding is merely an example of direct determination of one or more keyword signals and other examples exist.

In one embodiment, the display document request receiver module 306 determines the one or more keyword signals indirectly. For example, assume, again, the display document request is a search query, in one embodiment, a search server 180 or other server determines the one or more keyword signals. The display document request receiver module 306 receives the one or more keyword signals and determines the one or more received keyword signals are the one or more keyword signals associated with the requested display document request. In another example, assume the requested display document includes a digital video associated with metadata provided by a user that input one or more keyword signals associated with the digital video, in one embodiment, the display document request receiver module 306 receives/retrieves the one or more keywords signals and determines the one or more received/retrieved keyword signals are the one or more keyword signals associated with the user provided metadata. It will be recognized that the preceding are merely examples of indirect determination of one or more keyword signals and other examples exist. Moreover, it will be recognized that the preceding are merely examples of determining one or more keyword signals and that other examples exist.

In one embodiment, the display document request receiver module 306 passes the one or more keyword signals to the ad selection module 308 and (depending on the embodiment) to the optional topic determination module 310. For example, the display document request receiver module 306 is communicatively coupled to the ad selection module 308 to send the one or more keyword signals to the ad selection module 308, and (depending on the embodiment) is communicatively coupled to the topic determination module 310 to send the one or more keyword signals to the topic determination module 310. In another embodiment, the display document request receiver module 306 (or the communication interface 302) stores the one or more keyword signals in the storage device 214 (or any other non-transitory storage medium communicatively accessible). The other modules of the ad module 220, for example, one or more of the ad selection module 308 and the topic determination module 310, can retrieve the one or more keyword signals by accessing the storage device 214 (or other non-transitory storage medium).

The ad selection module 308 may include code and routines for selecting one or more advertisements. In one embodiment, the ad selection module 308 is a set of instructions executable by the processor 206. In another embodiment, the ad selection module 308 is stored in the memory 208 and is accessible and executable by the processor 206. In either embodiment, the ad selection module 308 is adapted for cooperation and communication with the processor 206, other components of the computing device 200 and other components of the ad module 220.

The ad selection module 308 selects an advertisement. In one embodiment, the ad selection module 308 selects an advertisement based at least in part on the one or more keyword signals. For example, in one embodiment, the ad selection module 308 compares the one or more keyword signals associated with the document request received by the display document request receiver module 306 to the one or more keyword signals associated with the one or more advertisements received by the enrollment module 304 and selects one or more advertisements based at least in part on a match between the keyword signal(s) associated with the display document request and the keyword signal(s) associated with the one or more advertisements.

In one embodiment, the selection of one or more MPCS Ads is separate from the selection of other forms of advertisement. For example, in one embodiment, the ad selection module 308 selects one or more MPCS Ads and another module (not shown) selects one or more advertisements from other forms of advertisement. In another example, in one embodiment, the ad selection module 308 selects one or more MPCS Ads and one or more advertisements from other forms of advertisement separately. It will be recognized that the preceding are merely examples of selecting one or more MPCS Ads separately from the other forms of advertising and that other examples exist.

In one embodiment, at least one MPCS Ad is selected by the ad selection module 308. In one embodiment, the selection of one or more MPCS Ads is performed separately from the selection of other forms of advertising because an MPCS Ad may not otherwise be selected by the ad selection module 308. Examples of reasons a MPCS Ad may not otherwise be selected include but are not limited to keyword signal matching, financial metrics, number of MPCS Ads, etc. It will be recognized that the preceding are merely examples of reasons a MPCS Ad may not otherwise be selected and that other examples exist.

In one embodiment, a MPCS Ad may be selected separately because a MPCS Ad may not otherwise be selected based at least in part on keyword signal matching. For example, assume a limited number of advertisements (e.g. 5) are displayed with a display document and that, in one embodiment, the ad selection module 308 selects the five most relevant ads (e.g. based at least in part on one or more keyword signals) from both MPCS Ads and other forms of advertisement. It may be possible for the five most relevant advertisements to not include a MPCS Ad, because, for example, an advertiser associates an MPCS Ad with broad keyword signals which not match/be as relevant to the keyword signal(s) associated with a document request as the keyword signals associated with advertisements having other forms of advertisement. It will be recognized that the preceding is merely an example of selecting a MPCS separately because a MPCS Ad may not otherwise be selected based at least in part on keyword signal matching and that other examples exist.

In one embodiment, a MPCS Ad may be selected separately because a MPCS Ad may not otherwise be selected based at least in part on a financial metric. In one embodiment, the ad selection module 308 selects an advertisement based at least in part on one or more financial metrics. Examples of financial metrics include but are not limited to ad server financial metrics, advertiser financial metrics, etc. It will be recognized that the preceding are merely examples of financial metrics and that other examples exist.

In one embodiment, the financial metric may be an ad server financial metric. For example, assume the operator of the ad server 101 receives a portion of revenue generated from each advertisement, in one embodiment, the ad selection module 308 selects an advertisement based at least in part on how much revenue the operator of the ad server 101 receives (i.e. a financial metric). In one embodiment, a MPCS Ad generates little or no revenue compared to other forms of advertisement. For example, a MPCS Ad is an advertisement that is not intended to and/or does not directly lead to a transaction or monetization. For example, in one embodiment, a MPCS Ad is intended to build the brand associated with the MPCS Ad and not to conduct a transaction (e.g. make a sale). In one embodiment, a transaction a cannot occur via a MPCS Ad because, for example, the multi-party communication space server 170 does not support that ability (e.g. not communicatively coupled to current inventory, credit card servers for processing a transaction, etc.). In some embodiments, the ad server financial metric for a MPCS Ad may be such that, if the MPCS Ad is not selected separately from the other forms of advertising, the ad selection module 308 would not select a MPCS Ad. It will be recognized that the preceding is merely an example of an ad server financial metric and that other examples exist. Furthermore, it will be recognized that the preceding is merely an example of selecting a MPCS separately because a MPCS Ad may not otherwise be selected based at least in part on an ad server financial metric and that other examples exist.

In one embodiment, the financial metric may be an advertiser financial metric. For example, assume the financial metric is a measure of the cost of an advertisement per dollar of revenue generated from the advertisement and/or per click on the advertisement and that, in one embodiment, the ad selection module 308 selects an advertisement based at least in part on the financial metric. According to the example, a MPCS Ad may not otherwise be selected for one or more reasons. One possible reason is that, in one embodiment, a MPCS Ad may be more expensive than other forms of advertising. For example, a MPCS Ad is associated with a multi-party communications session associated with a moderator and the moderator is likely paid for his/her service as a moderator thereby driving up the cost of a MPCS Ad. Another possible reason is that, in one embodiment, a MPCS Ad generates little or no revenue compared to other forms of advertisement. For example, a MPCS Ad is an advertisement that is not intended to and/or does not directly lead to a transaction or monetization. For example, in one embodiment, a MPCS Ad is intended to build the brand associated with the MPCS Ad and not to conduct a transaction (e.g. make a sale). Therefore, the revenue directly attributable to the MPCS Ad may be low. In one embodiment, a transaction a cannot occur via a MPCS Ad because, for example, the multi-party communication space server 170 does not support that ability (e.g. not communicatively coupled to current inventory, credit card servers for processing a transaction, etc.). In some embodiments, the advertiser financial metric for a MPCS Ad may be such that, if the MPCS Ad is not selected separately from the other forms of advertising, the ad selection module 308 would not select a MPCS Ad. It will be recognized that the preceding is merely an example of an advertiser financial metric and that other examples exist. Furthermore, it will be recognized that the preceding is merely an example of selecting a MPCS separately because a MPCS Ad may not otherwise be selected based at least in part on an advertiser financial metric and that other examples exist. Moreover, it will be recognized that the preceding are merely examples of selecting a MPCS separately because a MPCS Ad may not otherwise be selected based at least in part on a financial metric and that other examples exist.

In one embodiment, a MPCS Ad is an advertisement that builds a brand. In one embodiment, a MPCS Ad is an advertisement that builds the brand associated with the MPCS Ad. For example, in the example above, because of the MPCS Ad, XYZ Brand receives goodwill from the user who visited the multi-party communication session and has a stronger brand because of it. It will be recognized that the preceding is merely an example of building a brand associated with the MPCS Ad and that other examples exist.

In one embodiment, a MPCS Ad is an advertisement that builds a brand associated with the display document. For example, assume the display document is search results from Search Provider A for a user that searched for “cop sunglasses.” Also assume that the search results did not include the sunglasses the user was looking for, but a MPCS Ad is displayed with the search results. In one embodiment, the user may select the MPCS Ad connecting the user's user device 115 with a user device 115 associated with a moderator (e.g. a moderator associated with a popular brand of sunglasses) and the moderator suggests a search query, for example, the moderator suggests the search query “mirrored aviator sunglasses,” which produces better search results for the user. Users may become loyal to Search Provider A because the users may receive help searching when necessary via the MPCS Ads. Such embodiments may be especially beneficial to and appreciated by less savvy users. It will be recognized that the preceding is merely an example of building a brand associated with the display document and that other examples exist.

In one embodiment, the ad selection module 308 limits the number of MPCS Ads selected. For example, in one embodiment, the ad selection module 308 limits the number of MPCS ads to one at most. It will be recognized that the preceding is merely an example of limiting the number of MPCS Ads selected and that other examples exist.

In one embodiment, the ad selection module 308 limits the number of MPCS Ads selected makes a selected MPCS Ad more valuable to one or more of the operator of the ad server 101, the host of the display document (e.g. a website) and a company associated with a MPCS Ad. For example, a company's brand may acquire greater goodwill if it is the only brand associated with an MPCS Ad on the display document. In another example, an advertiser may better compensate the operator of the ad server 101 and/or the host of the display document if only that advertiser's MPCS Ad is displayed. In yet another example, a host of a display document may receive more ad revenue by displaying more other forms of advertisement than MPCS Ads with the display document. It will be recognized that the preceding are merely examples of how limiting the number of MPCS Ads selected may add value and that other examples exist.

In one embodiment, the ad selection module 308 limits the number of MPCS Ads selected based at least in part on system resources. For example, in one embodiment, a MPCS includes a link to an associated multi-party communication session and additional information. Assume the additional information when displayed to the user places greater demand on system resources (e.g. one or more of bandwidth, RAM, etc.) than other forms of advertising, in one embodiment, the ad selection module 308 limits the number of selected MPCS Ads in order to ensure that the display document with the MPCS Ad(s) loads quickly. It will be recognized that the preceding is merely an example of limiting the number of MPCS Ads selected based at least in part on system resources and that other examples exist.

In one embodiment, the ad selection module 308 selects a MPCS Ad based at least in part on one or more filtering criteria. Examples of filtering criteria include but are not limited to one or more of whether a multi-party communication session associated with a MPCS Ad is active, a quality metric, etc. It will be recognized that the preceding are merely examples of one or more filtering criteria and that other examples exist.

In one embodiment, the ad selection module 308 selects a MPCS Ad based at least in part on whether the associated multi-party communication session is active. In one embodiment, the ad selection module 308 determines whether a multi-party communication session is active based at least in part on information received by the enrollment module 304. For example, assume the enrollment module 304 received information from the advertiser that the multi-party communication session is staffed with a moderator from 9 am-5 pm EST, in one embodiment, the ad selection module 308 selects, or does not select, that MPCS Ad based at least in part on whether the display document request was received by the display document receiver module 306 between 9 am and 5 pm EST. It will be recognized the preceding is merely an example of determining whether a multi-party communication session is active based at least in part on multi-party communication session information received by the enrollment module 304 and that other examples exist.

In one embodiment, the ad selection module 308 determines whether a multi-party communication session is active based at least in part on a signal received from the multi-party communication space server 170. For example, assume the ad selection module 308 is communicatively coupled to the multi-party communication space server 170 to receive a login signal when a moderator is logged into a multi-party communication session associated with a MPCS Ad. In one embodiment, the ad selection module 308 selects a MPCS Ad based at least in part on the signal. It will be recognized that the preceding is merely an example of a signal received from the multi-party communication space server 170 and that other examples exist. Furthermore, it will be recognized that the preceding is merely an example of determining whether a multi-party communication session is active based at least in part on a signal received from the multi-party communication space server 170 and that other examples exist.

In one embodiment, the ad selection module 308 determines whether a multi-party communication session is active based at least in part on a signal received from a moderator via a user device 115. For example, assume the enrollment module 304 is communicatively coupled to one or more user devices 115 and receives a signal when a moderator is present in a multi-party communications session, in one embodiment, the ad selection module 308 selects, or does not select, the MPCS Ad based at least in part on whether the signal is received from the moderator. It will be recognized that the preceding is merely an example of determining whether a multi-party communication session is active based at least in part on a signal received from a moderator via a user device 115 and that other examples exist. Moreover, it will be recognized that the preceding are merely examples of determining whether a multi-party communication session associated with a MPCS Ad is active and other examples exist.

In one embodiment, the ad selection module 308 selects a MPCS Ad based at least in part on a quality metric. Examples of a quality metric include but are not limited to one or more of a user rating (e.g. whether users find the associated multi-party communication session helpful, useful, or responsive), number of clicks (e.g. whether users are visiting the associated multi-party communication session), participation (e.g. the average number of people in the associated multi-party communication session), etc. It will be recognized that the preceding are merely examples of quality metrics and that other examples exist.

In one embodiment, the ad selection module 308 passes the selected advertisement to one or more of the ad display module 312 and (depending on the embodiment) the optional topic determination module 310. For example, the ad selection module 308 is communicatively coupled to the ad display module 312 to send the selected advertisement to the ad display module 312, and (depending on the embodiment) is communicatively coupled to the optional topic determination module 310 to send the selected advertisement to the optional topic determination module 310. In another embodiment, the ad selection module 308 (or the communication interface 302) stores the selected advertisement in the storage device 214 (or any other non-transitory storage medium communicatively accessible). The other modules of the ad module 220, for example, one or more of the ad display module 312 and the optional topic determination module 310, can retrieve the selected advertisement by accessing the storage device 214 (or other non-transitory storage medium).

The optional topic determination module 310 may include code and routines for selecting at least on named topic associated with a MPCS Ad. In one embodiment, the topic determination module 310 is a set of instructions executable by the processor 206. In another embodiment, the topic determination module 310 is stored in the memory 208 and is accessible and executable by the processor 206. In either embodiment, the topic determination module 310 is adapted for cooperation and communication with the processor 206, other components of the computing device 200 and other components of the ad module 220.

In some embodiments, a MPCS Ad is associated with at least one named topic. In one embodiment, the topic determination module 310 selects the at least one named topic associated with an MPCS Ad. In one embodiment, the topic determination module 310 selects at least one named topic based at least in part on one or more topic specifying inputs.

In one embodiment, a topic specifying input may include the one or more keyword signals associated with the requested display document and received by the display document request receiver module 306. In one such embodiment, the topic determination module 310 selects the named topic based on the one or more keyword signals associated with the display document request. For example, assume the keyword signals included “vodka,” “tequila,” “rum,” and “gin,” in one embodiment, the topic determination module 310 selects (e.g. using a word association algorithm or other algorithm) the named topic “Long Island iced tea recipes.” For another example, assume the keyword signals include “chili recipe,” in one embodiment, topic determination module 310 selects “chili recipe” as the named topic. It will be recognized that the preceding are merely examples of selecting a named topic based at least in part on the one or more keyword signals associated with the requested display document and that other examples exist.

In one embodiment, a topic specifying input may include advertiser input associating one or more named topics with one or more of the keyword signals associated with the MPCS Ad. For example, assume an MPCS Ad is associated with keyword signals including “cookies,” “bread,” “pie,” “casseroles” and “cake.” Assume the enrollment module 304 also received input from the advertiser associating “cookies,” “pie” and “cake” with a “desserts” topic and “bread” and “casseroles” with a “baking” topic. Assume that the display document receiver module 306 receives a display document request associated with the keyword signal “pie,” in one embodiment, the topic determination module 310 selects the named topic “desserts” based at least in part on the advertiser's input associating the keyword signal “pie” with the named topic “desserts.” It will be recognized that the preceding is merely an example of selecting a named topic based at least in part on advertiser input associating one or more named topics with one or more of the keyword signals associated with the MPCS Ad and that other examples exist.

In one embodiment, a topic specifying input may include input from a moderator of the multi-party communication session associated with the MPCS Ad. For example, assume the MPCS Ad is associated with an automotive company and the associated multi-party communication session moderated by an employee of that automotive company. Assume also that the discussion in the multi-party communication session changes over time from a discussion about what to look for when buying a used car, to the difference between a sport and GT package on one of the automotive company's sedans, to tips and trick to ensure automotive reliability, etc. In one embodiment, the topic determination module 310 selects a named topic based at least in part on input from a moderator. For example, assume the moderator describes the current topic of discussion in the multi-party communication session by typing (i.e. inputting) “Tips and Tricks for Maximum Auto Reliability” into a text field, in one embodiment, the topic determination module 310 selects the named topic to be “Tips and Tricks for Maximum Auto Reliability.” For example, the topic determination module 310 is communicatively coupled to receive moderator input via a user device 115. It will be recognized that the preceding is merely an example of selecting a named topic based at least in part on input from a moderator of the multi-party communication session associated with the MPCS Ad and that other examples exist.

In one embodiment, a topic specifying input is based at least in part on input from a user. In one embodiment, the user input is a user question in the multi-party communications session. For example, assume a user asks “How do I tell when my turkey is done?” In one embodiment, the topic determination module 310 selects the named topic “How do I tell when my turkey is done?” It will be recognized that the preceding is merely an example of selecting a named topic based at least in part on a user question in the multi-party communications session and that other examples exist. Moreover, it will be recognized that the preceding is merely an example of selecting a named topic based at least in part on input from input from a user and that other examples exist.

In one embodiment, an input from a user is received by the topic determination module 310 when a user types the question into a text field. For example, assume the user inputs his/her question into a text field and the question is placed in a queue and the moderator answers questions in the queue, in one embodiment, the topic determination module 310 receives the queued question and selects the named topic based at least in part on that question. In one embodiment, an input from a user (such as a question) is received by the topic determination module 310 when a moderator or other human types the question into a text field. For example, assume the user verbally asks a question in the multi-party communication session and the moderator inputs the user's question into a text field, in one embodiment, the topic determination module 310 receives the question and selects the named topic based at least in part on that question. In one embodiment, an input from a user may is received by the topic determination module 310 when a user question is transcribed. For example, assume the multi-party communication session is transcribed and the user verbally asks his/her question, in one embodiment, the topic determination module 310 receives the question from the transcription and selects the named topic based at least in part on that question.

In some embodiments, the selected named topic does not necessarily include a keyword signal. For example, assume the advertiser associates the named topic “desserts” with the keyword signals that do not include “desserts.” For another example, selecting the named topic “Long Island iced tea recipes” based at least in part on keyword signals “vodka,” “tequila,” “rum” and “gin.” It will be recognized that the preceding are merely examples of selected named topics that do not include a keyword signal and that other examples exist.

While a selected named topic does not necessarily include a keyword signal, in some embodiments, the topic determination module 310 selects a named topic that does include a keyword signal. For example, assume a keyword signal associated with the requested display document is “cookies,” in one embodiment, the topic determination module 310 selects the named topic “baking cookies.” In another example, assume the keyword signals associated with the requested display document is the search query “how to cook a turkey,” in one embodiment, the topic determination module 310 selects the named topic that mirrors exactly or is very similar to the keyword signals (e.g. “how to cook a turkey” or “cooking a turkey”). By including a keyword signal associated with a requested display document the MPCS Ad may appear more relevant and/or of interest to users and result in an increased number of users who select the MPCS Ad. In one embodiment, the topic determination module 310 selects a named topic based at least in part on the named topic's relevance to the keyword signal(s) and/or the user's expected interest in the named topic. It will be recognized that the preceding are merely examples of selecting a named topic that includes a keyword signal and that other examples exist.

In one embodiment, the topic determination module 310 selects a named topic based at least in part on the accuracy of the current topic of discussion in the multi-party communication session. For example, assume the topic determination module 310 selects the named topic based at least in part on a topic specifying input describing the current topic of discussion in the multi-party communication session. In another example, assume the topic determination module 310 selects the named topic based at least in part on a user question that the moderator is answering in the multi-party communication session. Such embodiments beneficially may provide transparency and may provide users an accurate description of what they can expect in the associated multi-party communication session. It will be recognized that the preceding are merely examples of selecting a named topic based at least in part on the accuracy of the current topic of discussion in the multi-party communication session and that other examples exist.

In one embodiment, the topic determination module 310 executes responsive to the selection of an MPCS Ad by the ad selection module 308. For example, assume the MPCS Ad associated with “cookies,” “bread,” “pie,” “casseroles” and “cake,” in one embodiment, the topic determination module 310 receives/retrieves the one or more keyword signals received by the display document request receiver module 306 and selects a named topic (e.g. “baking” or “desserts”) based at least in part on a topic specifying input (e.g. input received from an advertiser). It will be recognized that the preceding is merely an example of the topic determination module 310 executing responsive to the selection of an MPCS Ad by the ad selection module 308 and that other examples exist.

In one embodiment, the named topic selected by the topic determination module 310 is dynamic. In one embodiment, the named topic selected by the topic determination module 310 is dynamic because a different named topic is associated with the same MPCS Ad at different times. For example, assume the user inputs the search query “cars” and that the named topic associated with the MPCS Ad is “Buying a Used Car: What to Look For” (e.g. based on topic specifying input from a moderator), in one embodiment, when the same user reloads the page at a later time the selected named topic associated with the same MPCS Ad and multi-party communication session may be “Tips and Tricks for Maximum Auto Reliability,” because, for example, the topic of discussion has changed and been updated by the moderator via a topic specifying input. It will be recognized that the preceding is merely an example of the named topic selected by the topic determination module 310 being dynamic over time and that other examples exist.

In one embodiment, the named topic selected by the topic determination module 310 is dynamic because a different named topic is associated with the same MPCS Ad responsive to different display document requests. For example, assume a first display document request is a search query and the associated keyword signal is “cookies,” and a second display document request is a request to view an e-mail and the associated keyword signal is “cookies.” In one embodiment, the topic determination module 310 selects the first named topic “baking cookies” and associates that with the MPCS Ad for display with the search results, and the topic determination module 310 selects the second named topic “baked goods” and associates that with the MPCS Ad for display with the e-mail. It will be recognized that the preceding is merely an example of the named topic selected by the topic determination module 310 being dynamic over display document request and that other examples exist.

In one embodiment, the named topic selected by the topic determination module 310 is dynamic because a different named topic is associated with the same MPCS Ad responsive to different keyword signals associated with the requested display document. For example, assume a first display document request is associated with the keyword signal “cookies,” and a second display document request associated with the keyword signal “bread.” In one embodiment, the topic determination module 310 selects the first named topic “desserts” and associates that with the MPCS Ad for display with first display document requested, and the topic determination module 310 selects the second named topic “baking” and associates that with the MPCS Ad for display with the second display document requested. It will be recognized that the preceding is merely an example of the named topic selected by the topic determination module 310 being dynamic over different keyword signals and that other examples exist. Moreover, it will be recognized that the preceding are merely examples of the named topic selected by the topic determination module 310 being dynamic and that other examples exist. For example, in some embodiments, the selected named topic may be dynamic based on the user associated with the display document request and/or that user's preferences.

In some embodiments, the topic determination module 310 selects different named topics to concentrate users into the same multi-party communication session associated with the MPCS Ad. For example, assume that the topic determination module 310 selects a first named topic “desserts” for display with results of a search query “cake” to a first user, a second named topic “baking” for display with results of a search query “bread” for display to a second user and a third named topic “cooking” for display with results of a search query “how to cook a turkey” for display to a third user. Also assume that the first, second and third user selected the MPCS Ad displayed because it appeared relevant to each. In one embodiment, the first, second and third users are all connected to the same multi-party communication session discussing food preparation. It will be recognized that the preceding is merely an example of selecting different named topics to concentrate users into the same multi-party communication session associated with the MPCS Ad. Concentration of the users may beneficially provide for more interesting and diverse discussions in the multi-party communication session. Concentration of the users may beneficially reduce the costs associated with MPCS Ads. For example, a company does not need to create and staff three different multi-party communication sessions for discussing desserts, baking and cooking Instead, the company may create a single multi-party communication session staffed by a moderator that discusses food preparation in general.

In one embodiment, the topic determination module 310 passes the named topic to the ad display module 312. For example, the topic determination module 310 is communicatively coupled to the ad display module 312 to send the named topic to the ad display module 312. In another embodiment, the topic determination module 310 (or the communication interface 302) stores the named topic in the storage device 214 (or any other non-transitory storage medium communicatively accessible). The other modules of the ad module 220 including the ad display module 312 can retrieve the named topic by accessing the storage device 214 (or other non-transitory storage medium).

The ad display module 312 may include code and routines for providing the selected advertisement for display. In one embodiment, the ad display module 312 is a set of instructions executable by the processor 206. In another embodiment, the ad display module 312 is stored in the memory 208 and is accessible and executable by the processor 206. In either embodiment, the ad display module 312 is adapted for cooperation and communication with the processor 206, other components of the computing device 200 and other components of the ad module 220.

In one embodiment, the ad display module 312 provides the one or more selected advertisement for display. In one embodiment, the ad display module 312 provides the advertisement for display with the display document requested. For example, assume the display document requested is a search result, in one embodiment, the ad display module 312 provides the advertisement for display with the search result. It will be recognized that the preceding is merely an example of providing an advertisement for display with the requested display document and that other examples exist.

In one embodiment, the ad display module 312 provides one or more selected MPCS Ads display. In one embodiment, a MPCS Ad comprises a selection element. Examples of selection elements include but are not limited to one or more of a hypertext link, button, pull-down menu, checkbox, etc. It will be recognized that the preceding are merely examples of selection elements and other examples exist.

In one embodiment, when the selection element is selected by a user, the user's user device 115 is connected to a user device associated with the one or more moderators. For example, assume the MPCS Ad comprises a hypertext link or button, in one embodiment, the ad display module 312 provides the hypertext link or button for display. It will be recognized that the preceding is merely an example of providing a MPCS Ad comprising a selection element for display and that other examples exist.

In one embodiment, whether the user device 115 associated with a user that selected the selection element is connected to a user device 115 associated with the one or more moderators responsive to the selection of the selection element is based at least in part on a user login. For example, assume that the user must log into the multi-party communication space server 170 (before or after selecting the selection element) prior to the user's user device 115 being connected to the user device associated with a moderator. It will be recognized that the preceding is merely an example of connecting the user device associated with the selection of a selection element to a user device associated with the one or more moderators based at least in part on a user login and that other examples exist.

In one embodiment, the ad display module 312 provides a MPCS Ad for display with its associated named topic. For example, assume the topic selection module 310 selects “cooking” as the named topic associated with an MPCS Ad, in one embodiment, the ad display module 312 obtains (e.g. receives or retrieves) “cooking” and provides “cooking” for display with the MPCS Ad. It will be recognized that the preceding is merely an example of providing a named topic for display with a MPCS Ad and that other examples exist.

In one embodiment, the ad display module 312 provides a limited number of MPCS Ads for display. For example, in one embodiment, the ad display module 312 provides one MPCS ad at most for display regardless of how many MPCS Ads are selected by the ad selection module 308. It will be recognized that the preceding is merely an example of limiting the number of MPCS Ads provided for display and that other examples exist.

In one embodiment, the ad display module 312 provides at least one MPCS Ad for display. For example, assume the ad selection module 308 selects at least one MPCS Ad, in one embodiment, the ad display module 312 provides the at least one MPCS Ad for display to the user. It will be recognized that the preceding is merely an example of limiting the number of MPCS Ads provided for display and that other examples exist.

In one embodiment, the ad display module 312 sends the selected advertisement for presentation to the user 125. For example, the ad display module 312 is communicatively coupled to the user device 115 to send the selected advertisement to the user device 115. In another embodiment, the ad display module 312 (or the communication interface 302) stores the selected advertisement in the storage device 214 (or any other non-transitory storage medium communicatively accessible). The other components of the system 100, e.g., the communication interface 302, can request the selected advertisement, which is retrieved by accessing the storage device 214 (or other non-transitory storage medium), and send the selected advertisement for presentation to the user 125.

### Example Processes

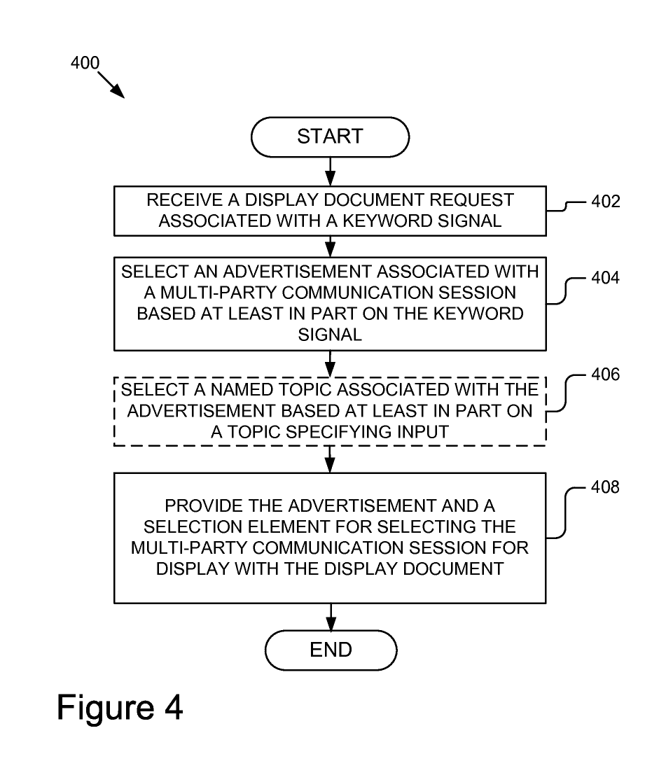

FIGS. 4, 5 and 6 depict various methods 400, 500, 600 performed by the system described above in reference to FIGS. 1-3. Steps that are optional or performed by optional modules are depicted in dashed blocks.

FIG. 4 is a flow chart illustrating a method 400 for generating an advertisement according to one embodiment. At block 402, the display document request receiver module 306 of the ad module 220 receives a display document request associated with a keyword signal. At block 404, the ad selection module 308 selects an advertisement associated with a multi-party communication session based at least in part on the keyword signal. At block 406, the optional topic determination module 310 selects a named topic of the multi-party communication session associated with the selected advertisement based at least in part on a topic specifying input. At block 408, the ad display module 312 provides the advertisement selected at block 404 and a selection element for selecting the multi-party communication session for display with the requested display document. In one embodiment, at block 408, the topic determined at block 406 is also provided for display with the requested display document.

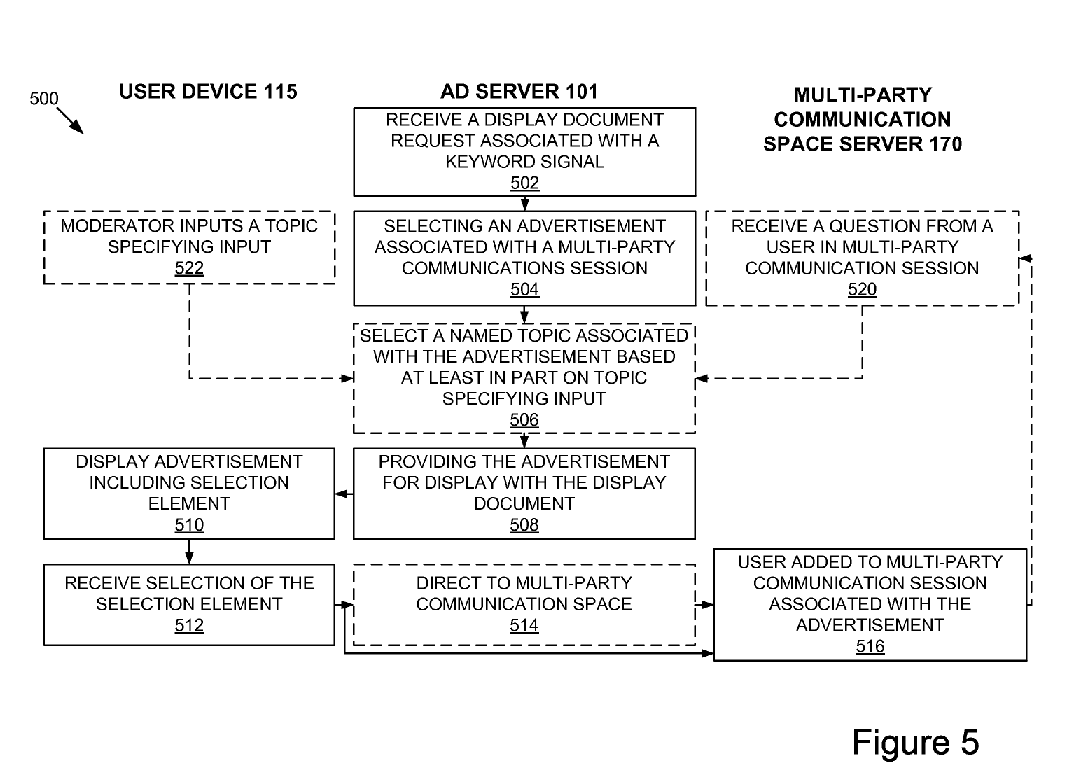

FIG. 5 is a flow chart illustrating another method 500 for generating an advertisement according to one embodiment. At block 502, the display document request receiver module 306 of the ad module 220 receives a display document request associated with a keyword signal. At block 504, the ad selection module 308 selects an advertisement associated with a multi-party communication session.

In some embodiments, an advertisement is associated with a named topic. At block 506, the optional topic determination module 310 selects a named topic associated with the selected advertisement based at least in part on a topic specifying input. In one embodiment, the topic determination module 310 selects the named topic associated with the advertisement based at least in part on a topic specifying input from the moderator at block 522. In one embodiment, the topic determination module 310 selects the named topic associated with the advertisement based at least in part on a question received from a user in the multi-party communication session at block 520.

At block 508, the ad display module 312 provides the advertisement selected at block 504 for display with the requested display document. In one embodiment, at block 508, the named topic selected at block 506 is also provided for display with the requested display document. At block 510, the advertisement including a selection element associated with the multi-party communication session and (depending on the embodiment) the named topic selected at block 506 is displayed to a user. At block 512, a selection of the selection element is received from a user. In one embodiment, responsive to the selection of the selection element, the ad server 101 directs the user to the multi-party communication space server 170, at block 514, where, at block 516, the user is added to the multi-party communication session associated with the advertisement. In another embodiment, responsive to the selection of the selection element at block 512, the user is added, at block 516, to the multi-party communication session associated with the advertisement.

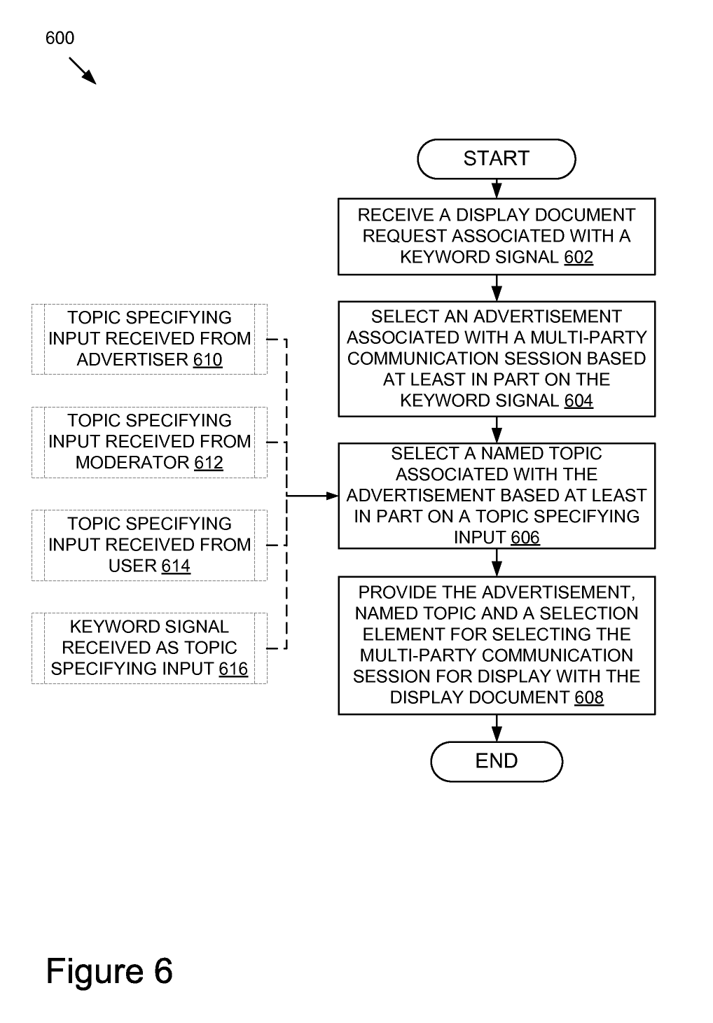

FIG. 6 is a flow chart illustrating yet another method 600 for generating an advertisement according to yet another embodiment. At block 602, the display document request receiver module 306 of the ad module 220 receives a display document request associated with a keyword signal. At block 604, the ad selection module 308 selects an advertisement associated with a multi-party communication session based at least in part on the keyword signal. At block 606, the topic determination module 310 selects a named topic associated with the selected advertisement based at least in part on a topic specifying input.

In one embodiment, the topic specifying input includes input from an advertiser associating one or more named topics with one or more of the keyword signals associated with the MPCS Ad received at block 610. In one embodiment, the topic specifying input includes input from a moderator of the multi-party communication session associated with the advertisement selected at block 504, the topic specifying input received at received at block 612. In one embodiment, the topic specifying input includes input from a user of the multi-party communication session associated with the advertisement selected at block 504, the topic specifying input received at received at block 614. In one embodiment, the keyword signal received at block 602 is received as a topic specifying input at block 616.

At block 608, the ad display module 312 provides the advertisement selected at block 604, the named topic selected at block 606 and a selection element for selecting the multi-party communication session for display with the requested display document.

The foregoing description of the embodiments has been presented for the purposes of illustration and description. It is not intended to be exhaustive or to limit the present embodiments to the precise forms disclosed. Many modifications and variations are possible in light of the above teaching. It is intended that the scope of the present embodiments be limited not by this detailed description, but rather by the claims of this application. As will be understood by those familiar with the art, the present embodiments may take other specific forms without departing from the spirit or essential characteristics thereof. Likewise, the particular naming and division of the modules, routines, features, attributes, methodologies and other aspects are not mandatory or significant, and the mechanisms that implement one embodiment or its features may have different names, divisions and/or formats. Furthermore, as will be apparent, the modules, routines, features, attributes, methodologies and other aspects of the embodiments can be implemented as software, hardware, firmware or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the embodiments are in no way limited to implementation in any specific programming language, or for any specific operating system or environment. Accordingly, the disclosure is intended to be illustrative, but not limiting, of the scope, which is set forth in the following claims.

What is claimed is:

1. A computer-implemented method for generating an advertisement, performed on one or more computing devices the method comprising:
receiving, using the one or more computing devices, a request for a display document, wherein the requested display document has associated therewith one or more keyword signals;
selecting, using the one or more computing devices, an advertisement based at least in part on the one or more keyword signals associated with the requested display document, wherein the advertisement includes additional information and is associated with a multi-party communication session and at least one named topic, wherein the multi-party communication session is associated with one or more moderators;
selecting, using the one or more computing devices, a named topic based at least in part on a topic specifying input; and
providing for display, using the one or more computing devices, the selected advertisement and the selected named topic with the display document, including providing for a selection element for selecting the multi-party communication session associated with the advertisement.

2. The method of claim 1, wherein the topic specifying input includes the one or more keyword signals associated with the requested display document, and the named topic is selected based at least in part on the one or more keyword signals.

3. The method of claim 1, wherein the topic specifying input is received from an advertiser and associates a potential named topic with one or more keyword signals associated with the advertisement, wherein the potential named is selected as the named topic when one or more keyword signals associated with the requested display document at least partially match the one or more keywords associated with the potential named topic.

4. The method of claim 1, wherein the one or more keyword signals are based at least in part on a search query.

5. The method of claim 1, wherein the one or more keyword signals are based at least in part on content of one or more e-mails.

6. The method of claim 1, wherein the one or more keyword signals are based at least in part on content of a webpage.

7. The method of claim 1, wherein the one or more keyword signals are based at least in part on content associated with a first user's social network account.

8. The method of claim 1, wherein the topic specifying input is based at least in part on a question from a user, the question submitted in the multi-party communication session associated with the advertisement.

9. The method of claim 1, wherein the topic specifying input comprises text typed by the one or more moderators into a text field and the named topic is selected based at least in part on the text.

10. The method of claim 1, wherein the topic specifying input is received from the one or more moderators and describes the current topic of the multi-party communication session associated with the advertisement.

11. The method of claim 1, wherein the named topic is dynamic.

12. A computer program product comprising a non-transitory computer readable medium encoding instructions that, in response to execution by a computing device, cause the computing device to perform operations comprising:
receiving, using the one or more computing devices, a request for a display document, wherein the requested display document has associated therewith one or more keyword signals;
selecting, using the one or more computing devices, an advertisement based at least in part on the one or more keyword signals associated with the requested display document, wherein the advertisement includes additional information and is associated with a multi-party communication session and at least one named topic, wherein the multi-party communication session is associated with one or more moderators;
selecting, using the one or more computing devices, a named topic based at least in part on a topic specifying input; and
providing for display, using the one or more computing devices, the selected advertisement and the selected named topic with the display document, including providing for a selection element for selecting the multi-party communication session associated with the advertisement.

13. A system for generating an advertisement, the system comprising:
a display document request receiver module operable to receive a request for a display document, wherein the requested display document has associated therewith one or more keyword signals;
an ad selection module operable to select an advertisement based at least in part on the one or more keyword signals associated with the requested display document, wherein the advertisement includes additional information and is associated with a multi-party communication session and at least one named topic, wherein the multi-party communication session is associated with one or more moderators, the ad selection module communicatively coupled to the display document request receiver module to receive the one or more keyword signals;
a topic determination module operable to select a named topic based at least in part on a topic specifying input, the topic determination module communicatively coupled to receive the topic specifying input; and
an ad display module operable to provide for display the selected advertisement and the named topic with the display document, including providing for a selection element for selecting the multi-party communication session associated with the advertisement, the ad display module communicatively coupled to the ad selection module to receive the selected advertisement.

14. The system of claim 13, wherein the topic specifying input includes the one or more keyword signals associated with the requested display document, and the named topic is selected by the topic determination module based at least in part on the one or more keyword signals.

15. The system of claim 13, further comprising:
An enrollment module operable for receiving the topic specifying input from an advertiser, the topic specifying input associating a potential named topic with one or more keyword signals associated with the advertisement; and
wherein the topic determination module selects the potential named topic when the one or more keyword signals associated with the requested display document at least partially match the one or more keywords associated with the potential named topic.

16. The system of claim 13, wherein the one or more keyword signals are based at least in part on a search query.

17. The system of claim 13, wherein the one or more keyword signals are based at least in part on content of one or more e-mails.

18. The system of claim 13, wherein the one or more keyword signals are based at least in part on content of a webpage.

19. The system of claim 13, wherein the one or more keyword signals are based at least in part on content associated with a first user's social network account.

20. The system of claim 13, wherein the topic specifying input is based at least in part on a question from a user, the question submitted in the multi-party communication session associated with the advertisement, and the topic determination module communicatively coupled to receive the question.

21. The system of claim 13, wherein the topic specifying input comprises text typed by the one or more moderators into a text field, wherein the topic determination module determines the named topic based at least in part on the text, the topic determination module communicatively coupled to receive the text typed by the one or more moderators.

22. The system of claim 13, wherein the topic specifying input is received from the one or more moderators and describes the current topic of the multi-party communication session associated with the advertisement, the topic determination module communicatively coupled to receive the topic specifying input from the one or more moderators.

23. The system of claim 13, wherein the named topic provided for display by the ad display module is dynamic.
